(19) United States
(12) Patent Application Publication
(10) Pub. No.: US 2023/0342615 A1
(43) Pub. Date: Oct. 26, 2023

(54) COMPUTER-READABLE RECORDING MEDIUM STORING TRAINING PROGRAM, TRAINING METHOD, AND INFORMATION PROCESSING APPARATUS

(71) Applicant: Fujitsu Limited, Kawasaki-shi (JP)

(72) Inventor: Hiroki TOKURA, Yokohama (JP)

(73) Assignee: Fujitsu Limited, Kawasaki-shi (JP)

(21) Appl. No.: 18/152,181

(22) Filed: Jan. 10, 2023

(30) Foreign Application Priority Data
Apr. 22, 2022 (JP) 2022-071055

(51) Int. Cl. G06N 3/084; G06N 3/0464

(52) U.S. Cl. CPC G06N 3/084; G06N 3/0464

(57) ABSTRACT

A recording medium stores a program for causing a computer to execute processing including: causing a convolution layer to execute a convolution calculation of forward propagation on first data output from a layer closer to an input side than the convolution layer; generating, when a pooling layer is caused to execute a pooling calculation of forward propagation on output data, an index in which a position of a non-zero element is set for each element of the output data; and causing, when the convolution layer is caused to execute a convolution calculation of backward propagation of the first data and second data that is output from a layer closer to an output side than the pooling layer, the convolution layer to execute a convolution calculation of a non-zero element based on the index, the input data, and the second data, and to skip a convolution calculation of a zero element.

### CROSS-REFERENCE TO RELATED APPLICATION

This application is based upon and claims the benefit of priority of the prior Japanese Patent Application No. 2022-71055, filed on Apr. 22, 2022, the entire contents of which are incorporated herein by reference.

### FIELD

The embodiment discussed herein is related to a training program and the like.

### BACKGROUND

In a technical field of deep learning, there is a convolutional neural network (CNN). The CNN is an important technology for improving image recognition performance, and has achieved a recognition rate equivalent to that of humans. In the following description, deep learning including the CNN is collectively referred to as CNN.

Japanese Laid-open Patent Publication No. 2018-055470 and Japanese Laid-open Patent Publication No. 2019-200553 are disclosed as related art.

### SUMMARY

According to an aspect of the embodiments, a non-transitory computer-readable recording medium stores a training program for causing a computer to execute processing including: causing a convolution layer included in a network to execute a convolution calculation of forward propagation on first input data output from a layer closer to an input side than the convolution layer; generating, when a pooling layer included in the network is caused to execute a pooling calculation of forward propagation on output data that serves as an execution result of the convolution calculation, an index in which a position of a non-zero element is set for each predetermined element of the output data; and causing, when the convolution layer is caused to execute a convolution calculation of backward propagation of the first input data and second input data that is output from a layer closer to an output side than the pooling layer, the convolution layer to execute a convolution calculation of a non-zero element based on the index, the first input data, and the second input data, and to skip a convolution calculation of a zero element.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing processing of forward propagation and backward propagation related to an existing convolution layer;

FIG. 2 is a diagram for describing processing of forward propagation and backward propagation related to an existing pooling layer;

FIG. 3 is a diagram (1) for describing processing of an information processing apparatus according to the present embodiment;

FIG. 4 is a diagram (2) for describing the processing of the information processing apparatus according to the present embodiment;

FIG. 5 is a diagram (3) for describing the processing of the information processing apparatus according to the present embodiment;

FIG. 6 is a functional block diagram illustrating a configuration of the information processing apparatus according to the present embodiment;

FIG. 7 is a diagram for describing processing of a calculation unit;

FIG. 8 is a flowchart illustrating a processing procedure of the information processing apparatus according to the present embodiment;

FIG. 9 is a diagram illustrating forward propagation of multi-channel convolution;

FIG. 10 is a diagram illustrating backward propagation of the multi-channel convolution;

FIG. 11 is a flowchart illustrating another processing procedure (1) of the information processing apparatus according to the present embodiment;

FIG. 12 is a diagram for describing data arrangement;

FIG. 13 is a diagram (1) illustrating a result of comparing execution time of an existing technology and the proposed embodiment;

FIG. 14 is a diagram for supplementarily describing processing in Step S201;

FIG. 15 is a diagram (1) for supplementarily describing processing in Step S203;

FIG. 16 is a diagram (2) for supplementarily describing the processing in Step S203;

FIG. 17 is a diagram (3) for supplementarily describing the processing in Step S203;

FIG. 18 is a diagram (4) for supplementarily describing the processing in Step S203;

FIG. 19 is a diagram for supplementarily describing processing in Step S204;

FIG. 20 is a flowchart illustrating another processing procedure (2) of the information processing apparatus according to the present embodiment;

FIG. 21 is a diagram (2) illustrating the result of comparing the execution time of the existing technology and the proposed embodiment;

FIG. 22 is a diagram for supplementarily describing processing in Step S301;

FIG. 23 is a diagram for supplementarily describing processing in Step S303;

FIG. 24 is a diagram for describing application to a partial weight (CV) difference output dw;

FIG. 25 is a diagram illustrating an example of a hardware configuration of a computer that implements functions similar to those of the information processing apparatus of the embodiment;

FIG. 26 is a flowchart illustrating a processing procedure of training of the existing technology; and

FIG. 27 is a diagram for describing processing of an existing maximum value pooling layer.

### DESCRIPTION OF EMBODIMENTS

In the CNN, full connection and a convolution calculation are often called “layers”. In the CNN, a specific layer tends to be used repeatedly. For example, in the CNN, an operation called a pooling layer for reducing an image size is performed after a convolution layer, and such a convolution layer and a pooling layer are used repeatedly.

A feature of the CNN is repetition of an enormous amount of calculation. Furthermore, a feature of the CNN is repetition of an operation called convolution (cross-correlation). Since time needed for the convolution operation takes up the majority of time, speeding up the calculation of the convolution may speed up calculation of the entire CNN.

In the CNN, a recognition rate and a correct answer rate are increased by repeating inference and training. In the following description, the recognition rate and the correct answer rate are simply referred to as recognition rate. A forward propagation calculation is performed in a case where inference is performed, and a backward propagation calculation is performed in a case where training is performed. Commonly, time needed for training is greater than time needed for inference.

Note that, in the CNN, in addition to parameters updated by training, there are fixed parameters that are set by a user, called hyperparameters. By adjusting the hyperparameters, the recognition rate may be further increased.

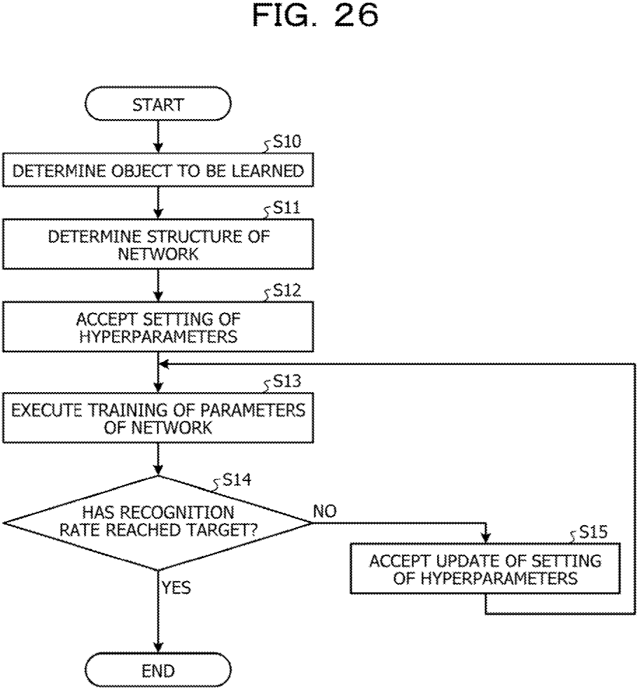

For example, in training in the CNN, parameters of a network are learned by a processing procedure as illustrated in FIG. 26. FIG. 26 is a flowchart illustrating a processing procedure of training of an existing technology. As illustrated in FIG. 26, in the existing technology, an object to be learned is determined (Step S10), and a structure of the network is determined (Step S11).

In the existing technology, setting of hyperparameters is accepted (Step S12), and training of the parameters of the network is executed (Step S13). In the existing technology, in a case where a recognition rate has reached a target (Step S14, Yes), the training ends.

On the other hand, in the existing technology, in a case where the recognition rate has not reached the target (Step S14, No), update of the setting of the hyperparameters is accepted (Step S15), and the processing proceeds to Step S13.

Note that, by trying as many combinations of the hyperparameters as possible, the network with a high recognition rate may be acquired. However, it has not been possible to try many hyperparameters because it takes time to complete the training. For example, the network tends to be huge to achieve the high recognition rate, a calculation amount is large, and time needed to complete the training may be a month or more. In order to shorten the time for the training, a group of servers is used, and accelerators such as a graphics processing unit (GPU) and a tensor processing unit (TPU) are used.

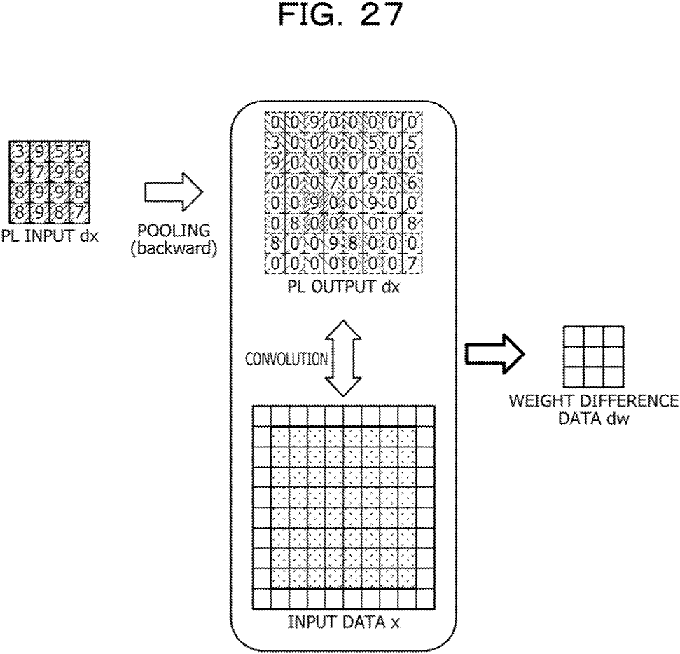

Subsequently, an existing maximum value pooling layer executed in the CNN will be described. FIG. 27 is a diagram for describing processing of the existing maximum value pooling layer. In the following description, the maximum value pooling layer is referred to as a pooling layer. Furthermore, in a plurality of layers which is included in the network and is arranged in a forward direction including the pooling layer, a layer before the pooling layer (layer on an input side) is referred to as “previous layer”, and a layer next to the pooling layer (layer on an output side) is referred to as “next layer”. Furthermore, it is assumed that a calculation of the pooling layer is a pooling calculation for each 2 × 2 elements.

The pooling layer acquires “PL input dx” from the next layer in a case where backward/forward calculations are performed during training. The pooling layer generates an image obtained by doubling the PL input dx both vertically and horizontally. The image obtained by doubling the PL input dx both vertically and horizontally is defined as “PL output dx”. The PL output dx includes only one non-zero element for each 2 × 2 elements. In the pooling layer, weight difference data dw is calculated by convolving input data x and the PL output dx in backward/forward calculations of normal convolution. The input data x is image data acquired from the previous layer. In the example of FIG. 27, 0 padding is executed on the input data x.

Here, in the CNN, a specific layer is often used continuously with a convolution layer, and for example, the convolution layer and the pooling layer are often continuous. Here, in the present specification, a calculation combining a calculation of a convolution layer and a calculation of another layer is referred to as “fusion calculation”. For example, a calculation combining a calculation of a convolution layer and a calculation of a pooling layer is the fusion calculation.

By performing the fusion calculation of the calculation of the convolution layer and the calculation of the pooling layer, it is possible omit a part of the calculation of the convolution layer. Furthermore, by performing the fusion calculation, in a case where backward propagation to the pooling layer is performed, it is possible to omit processing of outputting image data, and to reduce memory access.

For example, as described with reference to FIG. 27, the PL output dx includes only one non-zero element for each 2 × 2 elements. Thus, when convolution of such a non-zero element and the input data x may be calculated, it is possible to omit an unnecessary calculation, and to shorten time until training is completed. The unnecessary calculation is a convolution calculation of a zero element and the input data x.

However, in the existing calculation of convolution, it is not possible to specify which element is a non-zero element among 2 × 2 elements of the PL output dx. Thus, it is not possible to omit the unnecessary calculation, and to speed up training of the network.

In one aspect, an object of an embodiment is to provide a training program, a training method, and an information processing apparatus capable of speeding up training of a network.

Hereinafter, an embodiment of a training program, a training method, and an information processing apparatus disclosed in the present application will be described in detail with reference to the drawings. Note that the present disclosure is not limited by the embodiment.

### Embodiment

The information processing apparatus according to the present embodiment speeds up updating of a kernel (filter kernel) of a convolution layer in backward propagation by using a fusion calculation of the convolution layer and a pooling layer that are repeatedly used in a convolutional neural network (CNN). First, processing of forward propagation and backward propagation related to an existing convolution layer and pooling layer will be described.

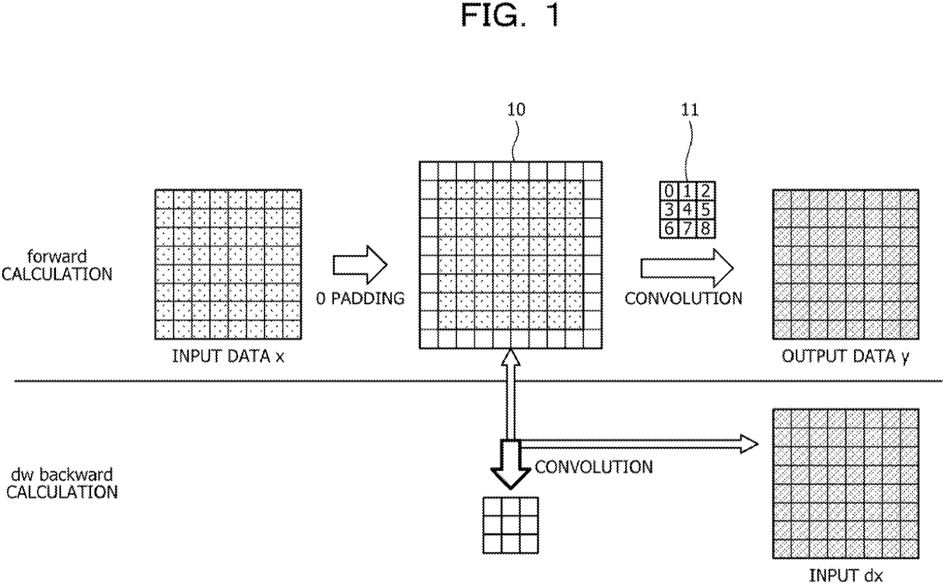

FIG. 1 is a diagram for describing the processing of forward propagation and backward propagation related to the existing convolution layer. As illustrated in FIG. 1, in a calculation of forward propagation (forward calculation), the convolution layer generates image data 10 by acquiring input data x from a previous layer and executing 0 padding on the input data x. By the 0 padding, pixels with a pixel value of 0 are set to an outer periphery of the input data x. The convolution layer executes a convolution calculation by using a kernel 11 with a kernel size of 3 × 3, and generates output data y.

On the other hand, in a calculation of backward propagation (dw backward calculation), the image data 10 used in the forward propagation and a difference image (input dx) propagated from the next layer are used. The convolution layer treats the image data 10 as an input image and the difference image (input dx) as a kernel. The difference image (input dx) in FIG. 1 corresponds to the PL output dx described with reference to FIG. 27.

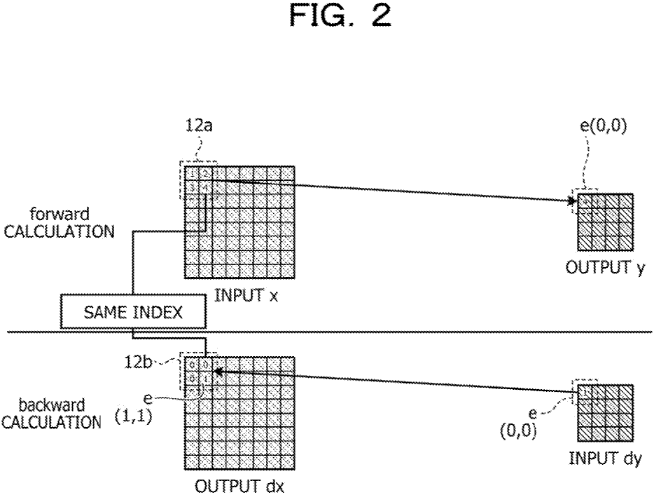

FIG. 2 is a diagram for describing processing of forward propagation and backward propagation related to the existing pooling layer. In FIG. 2, a case where a pooling calculation is performed for each 2 × 2 elements will be described. In a calculation of forward propagation (forward calculation), in the pooling layer, a maximum value is selected from 2 × 2 elements for an input x, and the selected maximum value is output.

For example, values of 2 × 2 elements included in an area 12a are 1, 2, 3, and 4. In the pooling layer, among the element values 1, 2, 3, and 4, the maximum value “4” is output to an element e(0, 0) of an output y. The element e(0, 0) indicates an element in the 0th row and the 0th column. In the forward propagation of the pooling layer, the output y is generated by repeatedly executing the processing described above while shifting a position of the area 12a. As a result, the output y (output image) is half a size of the input x (input image).

On the other hand, in backward propagation (backward calculation), the pooling layer uses the input image (input x) and the output image (output y) of the forward propagation. 2 × 2 elements of the input image (input x) corresponding to an element of the output image (output y) of the forward propagation are compared to specify an index of a matching element. In the pooling layer, for the matching index, an element of an input dy backpropagated from the next layer is written to a corresponding index (element indicated by the index) of an output image (output dx) of pooling. At this time, an element that is not written becomes 0.

For example, an element of the output dx corresponding to an element e(0, 0) of the input dy is e(1, 1). In the pooling layer, a value “1” of the element e(0, 0) of the input dy is written to the element e(1, 1) of the output dx. Furthermore, values of other elements in an area 12b are set to 0. In the backward propagation of the pooling layer, the output dx is generated by repeatedly executing the processing described above while specifying the element of the output dx corresponding to the element of the input dy.

The output dx in FIG. 2 includes only one non-zero element for each 2 × 2 elements. Thus, when convolution of such a non-zero element and the input data x may be calculated, it is possible to omit an unnecessary calculation, and to shorten time until training is completed. The unnecessary calculation is a convolution calculation of a zero element and the input data x.

Next, an example of processing of the information processing apparatus according to the present embodiment will be described. When fusing the convolution layer and the pooling layer, the information processing apparatus according to the present embodiment focuses on an operation pattern of the convolution layer and the pooling layer. In the present embodiment, it is assumed that a size of the input data x (image data) during the forward propagation of the convolution layer is “8 × 8”, the number of channels is “1”, and the number of patches is “1”. It is assumed that the kernel size is “3 × 3” and the number of kernel sets is “1”. In the convolution calculation, it is assumed that a slide is “1 × 1” and dilation is “1”. It is assumed that the information processing apparatus performs 0 padding on the input data x. The information processing apparatus performs pooling of the pooling layer with “2 × 2”.

As described with reference to FIG. 2, the calculation result image (output dx) in the backward propagation of the pooling layer has only one non-zero element in each 2 × 2 area. Note that, in the convolution layer, the calculation result image of the pooling layer is treated as a kernel, and convolution is performed with the input image of the convolution layer, so that a filter kernel of the convolution layer may be calculated. The filter kernel of the convolution layer corresponds to the weight difference data dw in FIG. 27.

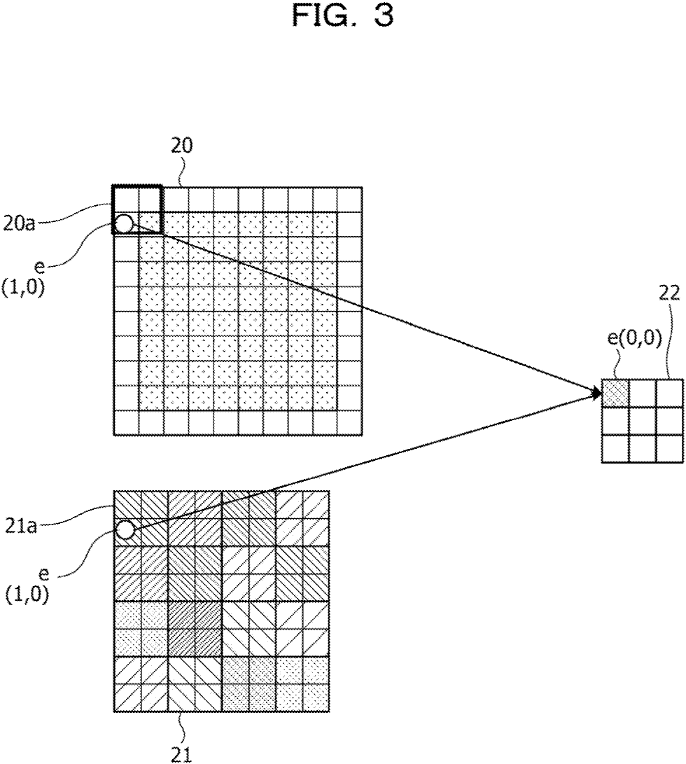

FIG. 3 is a diagram (1) for describing the processing of the information processing apparatus according to the present embodiment. In FIG. 3, an input image 20 is data obtained by performing 0 padding on the input data x. A calculation result image 21 corresponds to the calculation result image (output dx) in the backward propagation of the pooling layer. The calculation result image 21 has only one non-zero element for each 2 × 2 elements. Thus, when the information processing apparatus performs a convolution calculation by using only one element among the 2 × 2 elements of the calculation result image 21, it is possible to speed up a fusion calculation. In a case where a pooling size is 2 × 2, four-fold speedup is achieved by a simple calculation.

For example, it is assumed that e(1, 0) is a non-zero element among elements e(0, 0), e(0, 1), e(1, 0), and e(1, 1) in an area 21a of the calculation result image 21. In this case, in a case where a convolution calculation of an area 20a of the input image 20 and the area 21a of the calculation result image 21 is performed, the information processing apparatus may calculate a value of an element e(0, 0) of a filter kernel 22 of the convolution layer by performing a convolution calculation of an element e(1, 0) of the area 20a and the element e(1, 0) of the area 21a. For example, the information processing apparatus may skip a convolution calculation related to the elements e(0, 0), e(0, 1), and e(1, 1) of the area 21a.

The calculation result image 21 in the backward propagation of the pooling layer is repeatedly used in the filter kernel of the convolution layer. Thus, the information processing apparatus may efficiently execute a subsequent calculation by specifying which element is non-zero among 2 × 2 in advance, generating indexes indicating positions of the non-zero element and zero elements, and writing such a non-zero index to a memory.

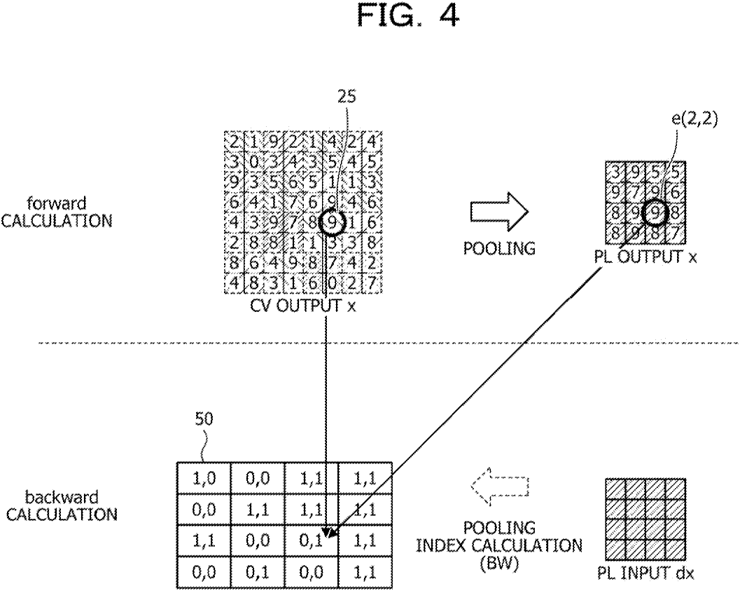

FIG. 4 is a diagram (2) for describing the processing of the information processing apparatus according to the present embodiment. With reference to FIG. 4, a method of calculating an index by the information processing apparatus will be described. In the calculation of an index, a CV output x and a PL output x used in the forward propagation are used. For example, the CV output x is generated by executing a convolution calculation on the input data x acquired from a previous layer. The PL output x is generated by executing a pooling calculation on the CV output x.

Here, 2 × 2 elements included in an area 25 of the CV output x corresponding to the respective elements of the PL output x are focused on. “9” set to an element e(2, 2) of the PL output x matches an element “9” of “0th row, 1st column” in the area 25 of the CV output x. In this case, the information processing apparatus sets a result of an index calculation “0, 1 (0th row, 1st column)” to an element in the 2nd row and the 2nd column of an index 50, which is an element corresponding to a position of the area 25. With this configuration, it is indicated that the element corresponding to “0, 1 (0th row, 1st column)” in the element in the 2nd row and the 2nd column of the index 50 is a non-zero element. The information processing apparatus focuses on 2 × 2 elements in another area included in the CV output x, and repeatedly executes the index calculation described above, thereby setting each value to each element of the index 50.

Note that, in a kernel filter backward propagation calculation using the index 50, calculation of pooling is skipped in backward propagation of pooling.

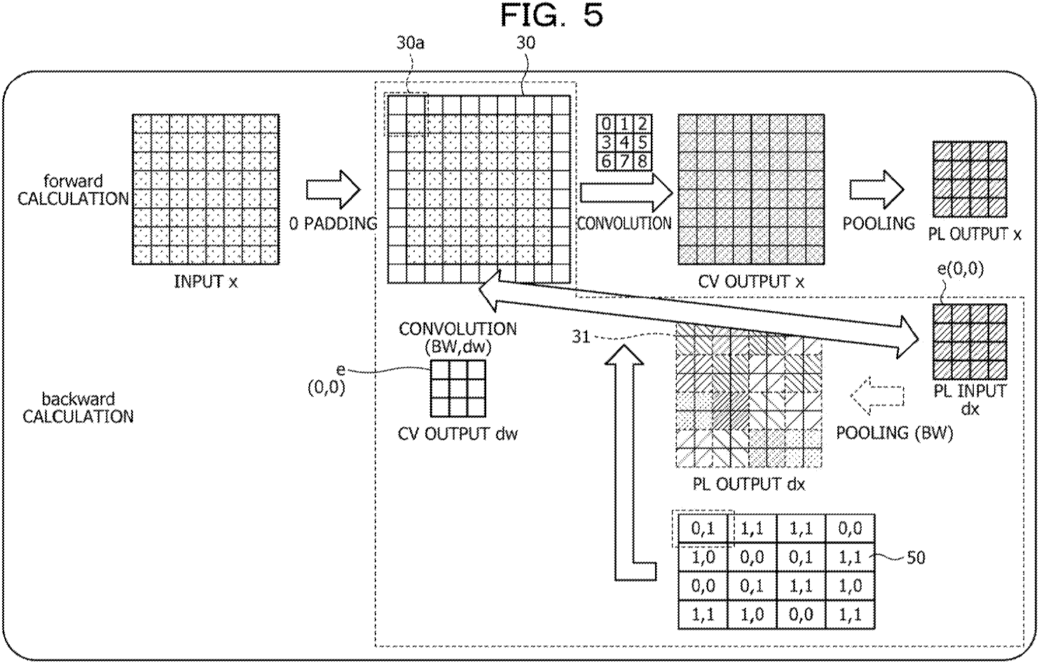

FIG. 5 is a diagram (3) for describing the processing of the information processing apparatus according to the present embodiment. In FIG. 5, the information processing apparatus calculates a CV output dw based on input data 30, the PL input dx, and the index 50. Note that, although not actually calculated, the PL output dx is generated by performing pooling (backward/forward) on the PL input dx. The PL output dx is indicated for convenience of description.

Here, as an example, a case of calculating a value of e(0, 0) of the CV output dw will be described. In this case, the information processing apparatus calculates e(0, 0) of the CV output dw by calculating convolution of an area 31 of the PL output dx and an area 30a of the input data 30. The information processing apparatus specifies “0, 1” corresponding to the area 31 of the PL output dx (the area 30a of the input data 30) among the respective elements of the index 50. With this configuration, the information processing apparatus specifies that “0th row, 1st column” in the area 31 is a non-zero element. The information processing apparatus sets a calculation result of convolution of a value of “0th row, 1st column” in the area 30a and a value of “0th row, 1st column” in the area 31 to e(0, 0) of the CV output dw.

Note that the PL output dx is not actually calculated, and the value of “0th row, 1st column” in the area 31 corresponds to a value of an element e(0, 0) of the PL input dx. Thus, the information processing apparatus sets a calculation result of convolution of the value of the element e(0, 0) of the PL input dx and the value of “0th row, 1st column” in the area 30a to the element e(0, 0) of the CV output dw.

The information processing apparatus also calculates a value of another element of the CV output dw by repeatedly executing the processing described above for the another element of the CV output dw.

As described above, in the case of performing the convolution calculation of the backward propagation, the information processing apparatus according to the present embodiment executes the convolution calculation only for the non-zero element by using the index indicating the position of the non-zero element, which is generated when performing the maximum pooling calculation of the forward propagation. With this configuration, it is possible to skip the convolution calculation for the zero elements and speed up training of the network.

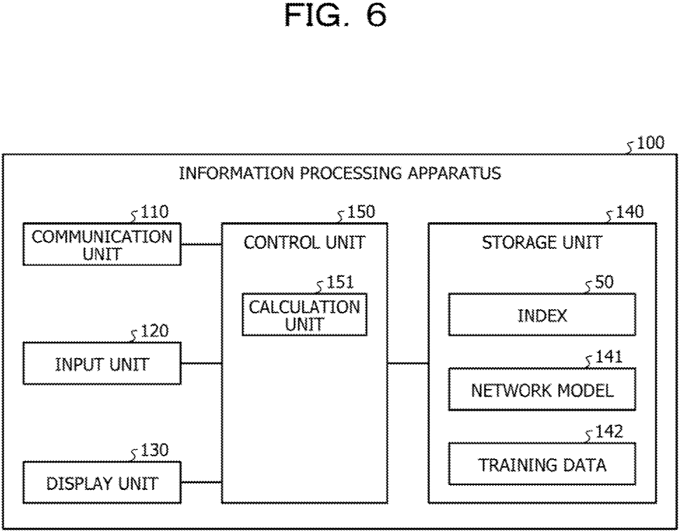

Next, a configuration example of the information processing apparatus that executes the processing described above will be described. FIG. 6 is a functional block diagram illustrating a configuration of the information processing apparatus according to the present embodiment. As illustrated in FIG. 6, an information processing apparatus 100 includes a communication unit 110, an input unit 120, a display unit 130, a storage unit 140, and a control unit 150.

The communication unit 110 executes data communication with an external device or the like. For example, the communication unit 110 is implemented by a network interface card (NIC) or the like.

The input unit 120 is implemented by using an input device such as a keyboard or a mouse.

The display unit 130 is implemented by a display device such as a liquid crystal display, or the like. The display unit 130 displays information output from the control unit 150.

The storage unit 140 is implemented by, for example, a semiconductor memory element such as a flash memory, or a storage device such as a hard disk or an optical disk. The storage unit 140 includes the index 50, a network model 141, and training data 142.

The index 50 is data generated by the processing described with reference to FIG. 4. As described with reference to FIG. 4, a position of a non-zero element is set to each element of the index 50.

In the network model 141, information regarding each layer included in the network, parameters set in each layer, and values of hyperparameters are set. The control unit 150 reads the network model 141, and executes training of parameters of the network.

The training data 142 is data used in a case where the network is learned, and associates pairs of input data (image data) and correct answer labels.

The control unit 150 includes a calculation unit 151. The control unit 150 is implemented by a central processing unit (CPU) or a micro processing unit (MPU). Furthermore, the control unit 150 may be executed by, for example, an integrated circuit such as an application specific integrated circuit (ASIC) or a field programmable gate array (FPGA).

The calculation unit 151 reads the network model 141, and performs inference and training by using the training data 142 and the network. When performing inference (forward calculation), the calculation unit 151 calculates the index 50 as described with reference to FIG. 4, and stores the index 50 in the storage unit 140. When performing training (dw backward calculation), the calculation unit 151 reads the index 50, specifies a non-zero element based on the index 50, and executes a calculation of convolution as described with reference to FIG. 5.

In the present embodiment, description will be made focusing on a calculation of convolution and a calculation of pooling performed by the calculation unit 151. Since description related to training and inference for another layer included in the network is similar to that in the existing technology, description thereof will be omitted.

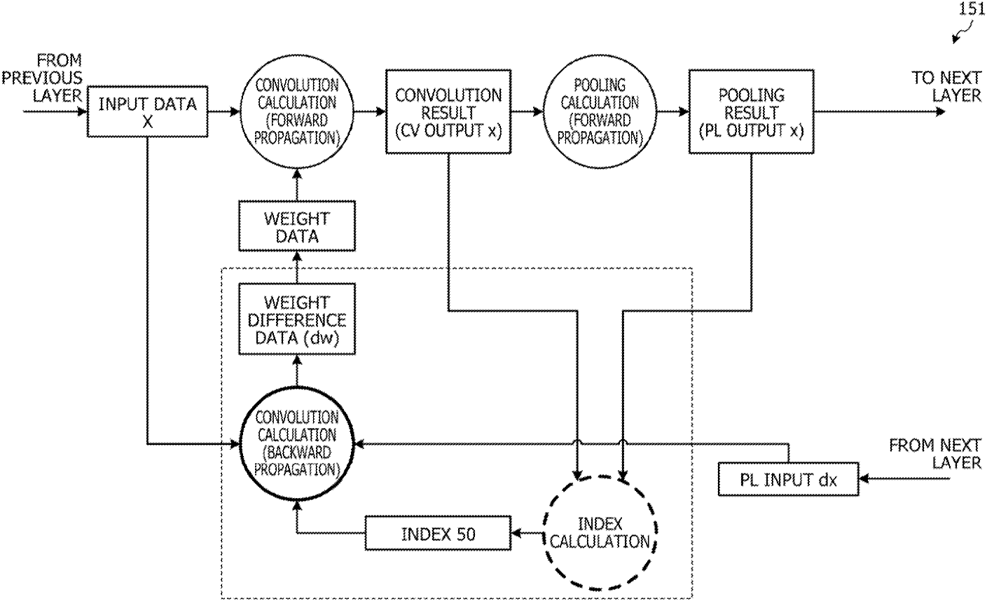

FIG. 7 is a diagram for describing processing of the calculation unit. The calculation unit 151 acquires the input data x from a previous layer. The calculation unit 151 executes a convolution calculation (forward propagation) between a filter based on weight data and the input data x, and outputs a convolution result (CV output x). The calculation unit 151 executes a pooling calculation (forward propagation) on the convolution result (CV output x), and outputs a pooling result (PL output x) to the next layer.

The calculation unit 151 performs an index calculation based on the convolution result (CV output x) and the pooling result (PL output x), and generates the index 50.

On the other hand, the calculation unit 151 acquires the PL input dx from the next layer. The calculation unit 151 executes a convolution calculation (backward propagation) of the PL input dx and the input data x, and calculates weight difference data (dw). The calculation unit 151 updates weight data based on the weight difference data (dw). Here, in the case of executing the convolution calculation (backward propagation) of the PL input dx and the input data x, the calculation unit 151 executes the convolution calculation only on a non-zero element by using the index 50.

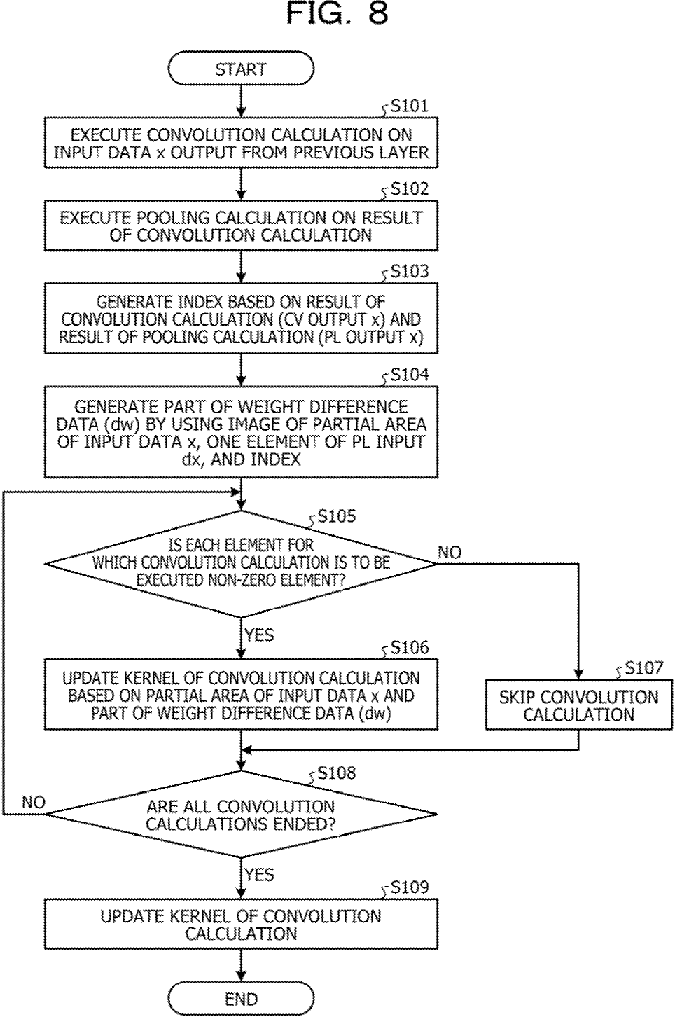

Next, an example of a processing procedure of the information processing apparatus according to the present embodiment will be described. FIG. 8 is a flowchart illustrating the processing procedure of the information processing apparatus according to the present embodiment. As illustrated in FIG. 8, the calculation unit 151 of the information processing apparatus 100 executes a convolution calculation on the input data x output from a previous layer (Step S101). The calculation unit 151 executes a pooling calculation on a result of the convolution calculation (Step S102).

The calculation unit 151 generates the index 50 based on the result of the convolution calculation (CV output x) and a result of the pooling calculation (PL output x) (Step S103). The calculation unit 151 generates a part of the weight difference data (dw) by using an image of a partial area (2 × 2) of the input data x, one element of the PL input dx, and the index (Step S104).

The calculation unit 151 determines whether or not each element for which the convolution calculation is to be executed is a non-zero element (Step S105). In a case where each element for which the convolution calculation is to be executed is a non-zero element (Step S105, Yes), the calculation unit 151 proceeds to Step S106. The calculation unit 151 updates a kernel of the convolution calculation based on the partial area of the input data x and the part of the weight difference data (dw) (Step S106), and proceeds to Step S108.

On the other hand, in a case where each element for which the convolution calculation is to be executed is not a non-zero element (Step S105, No), the calculation unit 151 skips the convolution calculation (Step S107), and proceeds to Step S108.

In a case where all the convolution calculations are not ended (Step S108, No), the calculation unit 151 proceeds to Step S105 again. In a case where all the convolution calculations are ended (Step S108, Yes), the calculation unit 151 updates the kernel of the convolution calculation (Step S109).

Next, effects of the information processing apparatus 100 according to the present embodiment will be described. In the case of performing the convolution calculation of the backward propagation, the information processing apparatus 100 executes the convolution calculation only for a non-zero element by using the index 50 indicating a position of the non-zero element, which is generated when performing the maximum pooling calculation of the forward propagation. With this configuration, it is possible to skip the convolution calculation for the zero elements and speed up training of the network.

The information processing apparatus 100 executes a convolution calculation of an element at a position of each predetermined element of the input data x and the element of the PL input dx, which correspond to the position of the non-zero element set in the index 50. With this configuration, it is possible to properly execute the convolution calculation only on the non-zero element.

The information processing apparatus 100 updates the kernel based on an execution result of the convolution calculation of the backward propagation. With this configuration, it is possible to perform training including parameters of the kernel at high speed.

Meanwhile, the embodiment described above is an example, and the information processing apparatus 100 according to the present embodiment may execute another processing. Hereinafter, the embodiment of the information processing apparatus 100 will be supplementarily described.

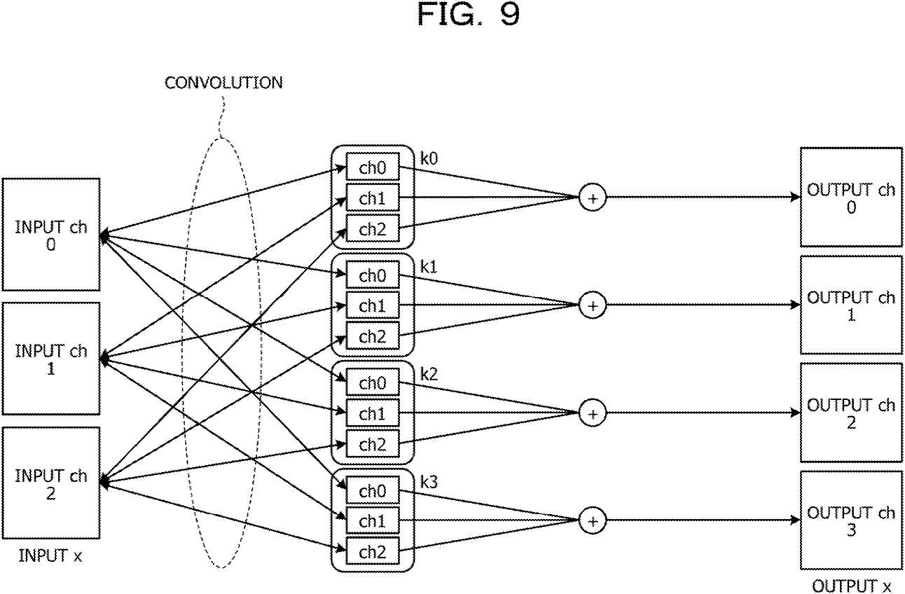

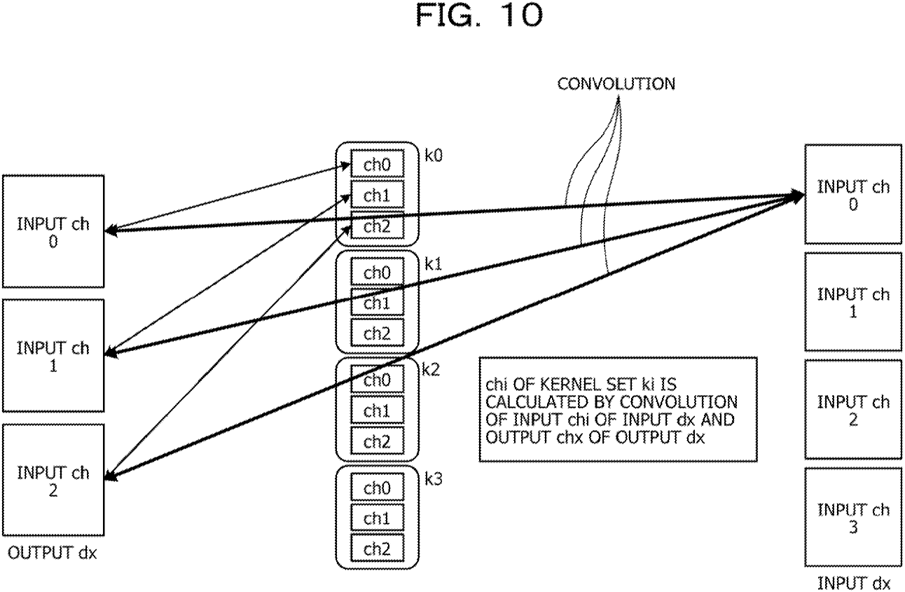

In the CNN, a convolution calculation is often performed on multiple channels. FIG. 9 is a diagram illustrating forward propagation of multi-channel convolution. FIG. 10 is a diagram illustrating backward propagation of the multi-channel convolution. For each of channels (ch0, ch1, and ch2) of each of kernel sets k0, k1, k2, and k3 indicated in FIGS. 9 and 10, the information processing apparatus 100 executes each processing described with reference to FIG. 5. For example, chi of a kernel set ki is calculated by convolution of an input chi of the input dx and an output chx of the output dx.

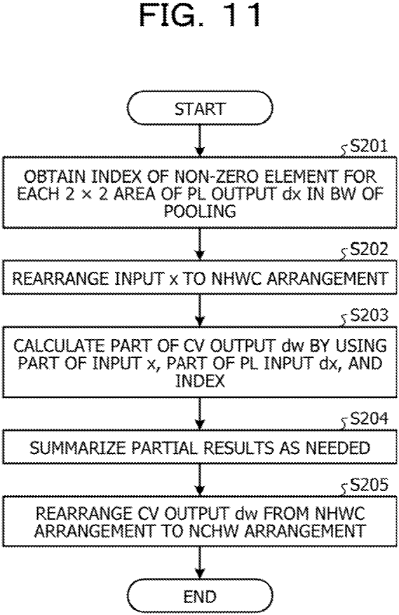

Next, another processing procedure (1) of the information processing apparatus 100 according to the present embodiment will be described. FIG. 11 is a flowchart illustrating the another processing procedure (1) of the information processing apparatus according to the present embodiment. In a case where processing in FIG. 11 is performed, it is assumed that all inputs and outputs are in NCHW arrangement.

As illustrated in FIG. 11, the calculation unit 151 of the information processing apparatus 100 obtains an index of a non-zero element for each 2 × 2 area of the PL output dx in backward (BW) of pooling (Step S201). The calculation unit 151 rearranges the input x to NHWC arrangement (Step S202).

The calculation unit 151 calculates a part of the CV output dw by using a part of the input x, a part of the PL input dx, and the index (Step S203). The calculation unit 151 summarizes partial results as needed (Step S204). The calculation unit 151 rearranges the CV output dw from the NHWC arrangement to the NCHW arrangement (Step S205).

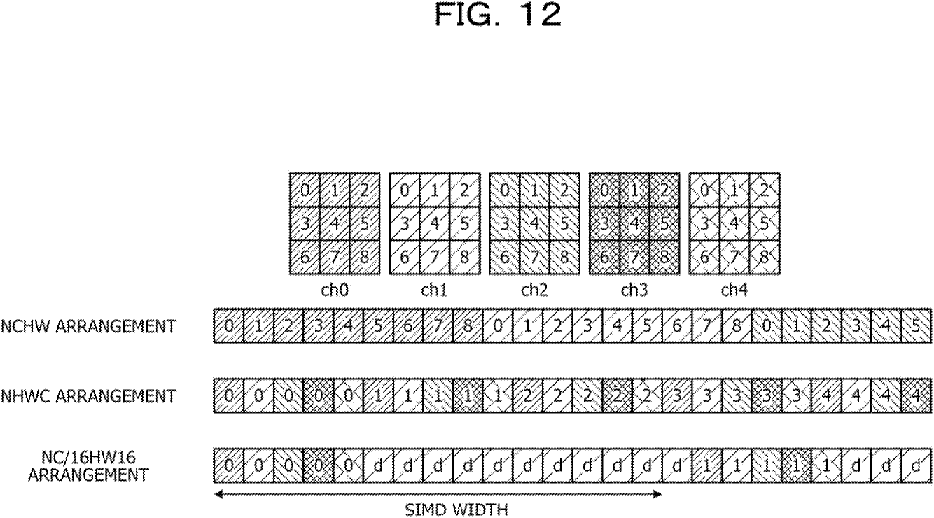

Here, data arrangement will be described with reference to FIG. 12. FIG. 12 is a diagram for describing the data arrangement. In the example indicated in FIG. 12, 3 × 3 elements are set to each of ch0, ch1, ch2, ch3, and ch4.

In the NCHW arrangement, the calculation unit 151 arranges data in order of each element of ch0, each element of ch1, each element of ch2, and each element of ch3.

In the NHWC arrangement, the calculation unit 151 repeatedly arranges data in order of an element of ch0, an element of ch1, an element of ch2, and an element of ch3 from the head of each ch.

In NC/16HW16 arrangement (single instruction multiple data (SIMD) width 16), the calculation unit 151 sets an optional value d between data of a previous element and data of a current element in a case where the NHWC arrangement described above is performed. The optional value d is, for example, “0”.

In the CNN, the convolution layer and the pooling layer appear repeatedly, and training is performed many times. Thus, when calculation of the backward propagation of the convolution layer and the pooling layer is speeded up even slightly, it is possible to greatly reduce time needed to complete training.

Comparing, by using a predetermined CPU, implementation (existing technology) that naively performs backward propagation calculations of the convolution layer and the pooling layer and implementation of the information processing apparatus 100 of the present embodiment, the present embodiment may achieve speedup by about 25% with a certain combination of parameters.

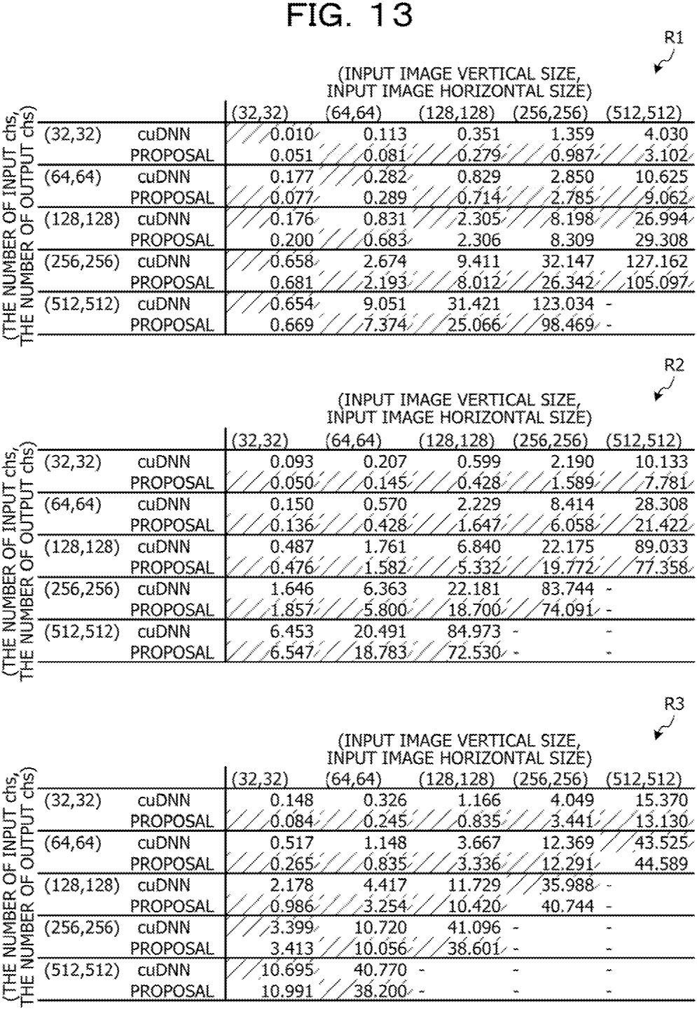

FIG. 13 is a diagram (1) illustrating a result of comparing execution time of the existing technology and the proposed embodiment. An execution result R1 in FIG. 13 is execution time in a case where a kernel size is 3 × 3. An execution result R2 is execution time in a case where the kernel size is 5 × 5. An execution result R3 is execution time in a case where the kernel size is 7 × 7.

A first line of the execution result R1 indicates execution time for the respective input image vertical/horizontal sizes (32, 32), (64, 64), (128, 128), (256, 256), and (512, 512) in a case where the number of input chs is 32 and the number of output chs is 32. Except for the input image vertical/horizontal size (32, 32), the execution time of the proposal is shorter than the execution time of the existing technology (cuCNN), and speedup is promoted. Although description of other rows of the execution result R1 is omitted, in most cases, the execution time of the proposal is shorter than the execution time of the existing technology (cuCNN), and speedup is promoted.

A first line of the execution result R2 indicates execution time for the respective input image vertical/horizontal sizes (32, 32), (64, 64), (128, 128), (256, 256), and (512, 512) in a case where the number of input chs is 32 and the number of output chs is 32. For all the input image vertical/horizontal sizes, the execution time of the proposal is shorter than the execution time of the existing technology (cuCNN), and speedup is promoted. Although description of other rows of the execution result R2 is omitted, the execution time of the proposal is shorter than the execution time of the existing technology (cuCNN), and speedup is promoted.

A first line of the execution result R3 indicates execution time for the respective input image vertical/horizontal sizes (32, 32), (64, 64), (128, 128), (256, 256), and (512, 512) in a case where the number of input chs is 32 and the number of output chs is 32. For all the input image vertical/horizontal sizes, the execution time of the proposal is shorter than the execution time of the existing technology (cuCNN), and speedup is promoted. Although description of other rows of the execution result R3 is omitted, the execution time of the proposal is shorter than the execution time of the existing technology (cuCNN), and speedup is promoted.

Subsequently, among Steps S201 to S205 described with reference to FIG. 11, the main part of the present embodiment will be described for each step. It is assumed that the input image and the output image are in the NCHW arrangement.

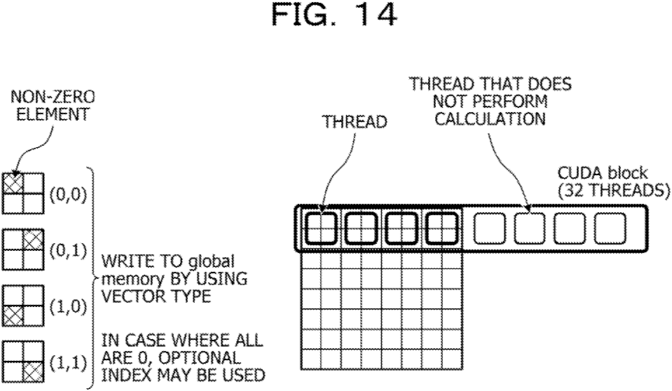

The processing in Step S201 in FIG. 11 will be described. FIG. 14 is a diagram for supplementarily describing the processing in Step S201. In the backward/forward calculations of pooling executed by the calculation unit 151, each thread obtains a non-zero index of 2 × 2 elements. It is assumed that an input 1 is “CV output x”, an input 2 is “PL output x”, and an output is “non-zero index”. The calculation unit 151 makes the non-zero index a vector type and writes the non-zero index to a global memory. At this time, the calculation unit 151 writes in the NCHW arrangement. Here, the PL output dx does not need to be written to the global memory in order to calculate the CV output dw. In a case where the PL output dx is needed for some other reason, it is sufficient that the PL output dx is written in the processing in Step S201.

The processing in Step S202 in FIG. 11 will be described. The calculation unit 151 converts the input x from the NCHW arrangement to the NHWC arrangement for an efficient calculation in steps after Step S202.

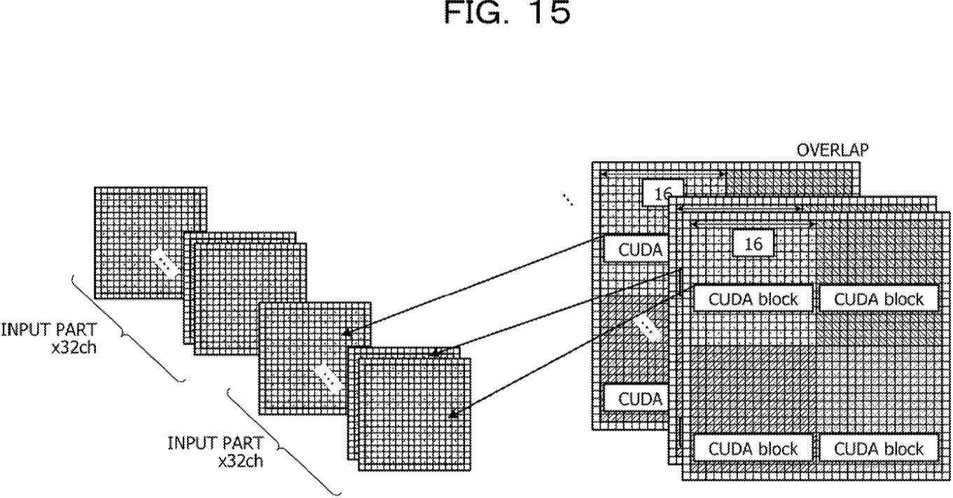

The processing in Step S203 in FIG. 11 will be described. FIGS. 15 to 18 are diagrams for supplementarily describing the processing in Step S203. Step S203 is divided into several detailed steps. First, it is indicated how the calculation unit 151 divides an image to perform the processing.

In a case where the input image is huge, the calculation unit 151 divides the input image to perform the processing. Each CUDA block indicated in FIG. 15 has 256 threads (32 threads × 8 warps). The calculation unit 151 performs the calculation by dividing the input x (NHWC) into partial input images (NHWC). A size of the partial image is (the number of chs = 32, the number of rows = 16 + 2, and the number of columns = 16 + 2). “+2” is overlap, which is commonly a value obtained by subtracting 1 from a kernel size.

The input x and the partial input images are in the NHWC arrangement, and the threads in the warp access different chs. Thus, since coreless access is made for the input x (NHWC), and different banks of a shared memory may be accessed for the partial input images (NHWC), it is possible to efficiently perform the processing. The partial input images (NHWC) are stored in the shared memory until the calculation is completed, and the input x (NHWC) is accessed only once.

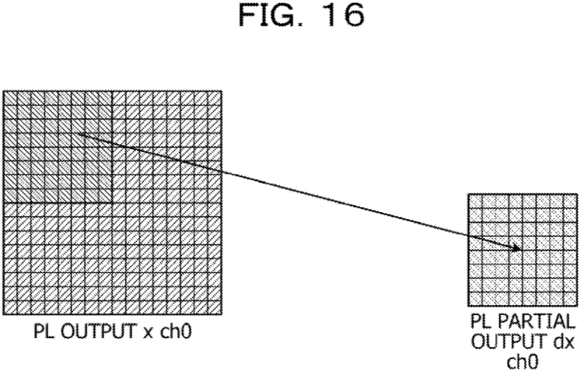

The description proceeds to FIG. 16. The calculation unit 151 causes the CUDA block to read a PL partial output dx of the PL output dx. The size is (ch = 8, H = 8, and W = 8). Here, the size of the PL partial output dx may be half that of the partial input image (NHWC). This is not a problem because the PL partial output dx subjected to implicit backward propagation of pooling has the same size. Regarding the number of chs, it is the same as the number of warps belonging to the CUDA block.

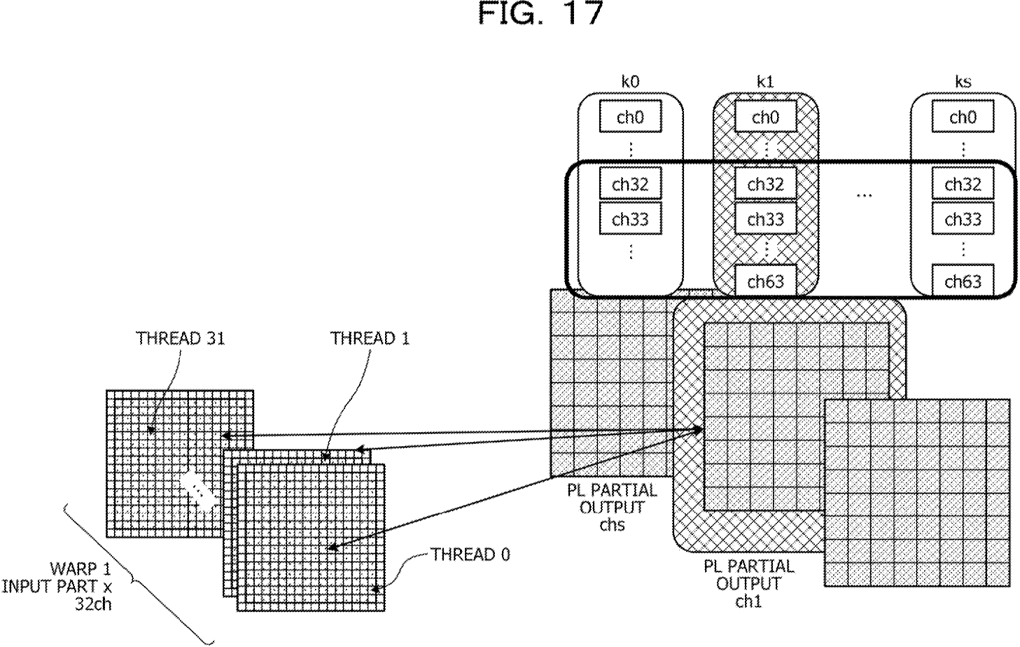

The description proceeds to FIG. 17. From now on, it will be described how the calculation unit 151 performs the calculation by assigning threads after causing the CUDA block to read the image. The CUDA block performs a calculation of a ch of a corresponding kernel. Note that, in a case where the number of chs of the kernel is greater than the number of warps belonging to the CUDA block, the calculation is performed by using a plurality of CUDA blocks. For example, a CUDA block 0: 0 to 31 chs, a CUDA block 1: 32 chs to 63 chs.

The CUDA block performs the calculation sequentially for all kernel sets, from a kernel set 0. A warp i of the CUDA block is in charge of calculating the kernel set ki. Here, in a case where the number of warps is smaller than the number of kernel sets, the calculation is repeatedly performed. For example, in a case where there are 17 chs, the 0th, 8th, and 16th kernel sets are calculated for a warp 0. The 1st and 9th kernel sets are calculated for a warp 1. The 2nd and 10th kernel sets are calculated for a warp 2. The 3rd and 11th kernel sets are calculated for a warp 3. The 4th and 12th kernel sets are calculated for a warp 4. The 5th and 13th kernel sets are calculated for a warp 5. The 6th and 14th kernel sets are calculated for a warp 6. The 7th and 15th kernel sets are calculated for a warp 7.

From now on, detailed steps when the calculation unit 151 executes S203 will be described. The partial input image (NHWC) of an area in charge is read to the shared memory including an overlapping sentence. Writing to the shared memory is performed in HWC arrangement. Note that a 0-padding area is out of range and treated as 0. At this time, 256 threads cooperate to perform reading. Note that the threads in the warp access the global memory by coalesced access, and access the shared memory without colliding with banks. After reading to the shared memory is performed, synchronization is performed with the 256 threads in the CUDA block.

In the subsequent processing, the processing is repeatedly performed for all the kernel sets asynchronously between warps.

The calculation unit 151 reads a PL partial input dx (NCHW) and an index (NCHW), which the warp i is in charge of. At this time, reading to the shared memory is performed with the following arrangement. The PL partial output dx is in HW arrangement. The index is in the HW arrangement.

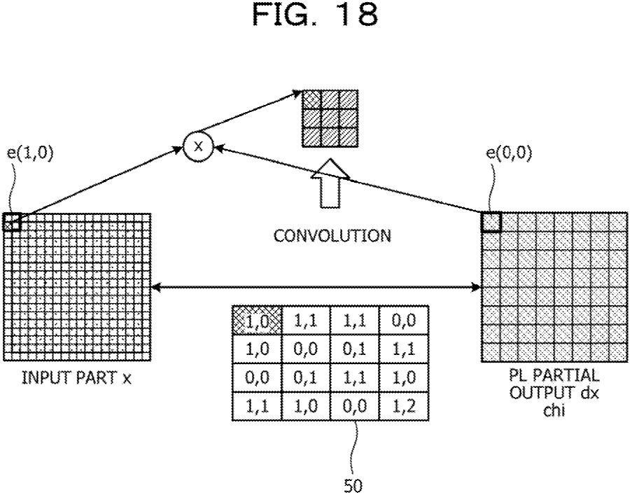

The description proceeds to FIG. 18. The calculation unit 151 performs, by using the index 50, convolution of an input part x and the PL partial output dx, which the warp i is in charge of. At this time, a calculation of a kernel element is performed line by line from the top of the PL partial output dx. For example, based on the index 50, the calculation unit 151 specifies an element e(1, 0) of the input part x, for which a convolution calculation with an element e(0, 0) of the PL partial output dx is to be executed. The calculation unit 151 calculates convolution of the element e(0, 0) of the PL partial output dx and the element e(1, 0) of the input part x.

Note that each thread accesses an element of a different ch in the input part x. Since storage is performed in the HWC arrangement in the shared memory, different banks are always accessed. Therefore, the threads within the warp may access the memory efficiently. For the PL partial output dx, the threads within the warp access the same element. Therefore, even when the same bank is accessed in the HW arrangement, the same address is accessed, so it is possible to perform memory access efficiently.

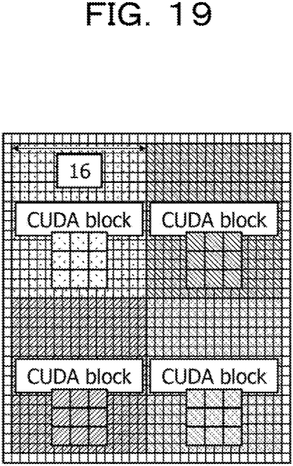

The processing in Step S204 in FIG. 11 will be described. FIG. 19 is a diagram for supplementarily describing the processing in Step S204. As described above, in a case where the input image x is large, the input image x is divided by the CUDA block and the processing is performed. At that time, it is needed to obtain a result of the CV output dw. It is sufficient that the calculation unit 151 calculates the sum of the kernels calculated by each CUDA block for each element. At this time, one thread calculates the sum total of one element.

The processing in Step S205 in FIG. 11 will be described. The calculation unit 151 converts the CV output dw from the NHWC arrangement to the NCHW arrangement. In a graphics processing unit (GPU), cudnn’s TransformTensor is used.

Among Steps S201 to S205 described with reference to FIG. 11, the main part of the present embodiment has been described above.

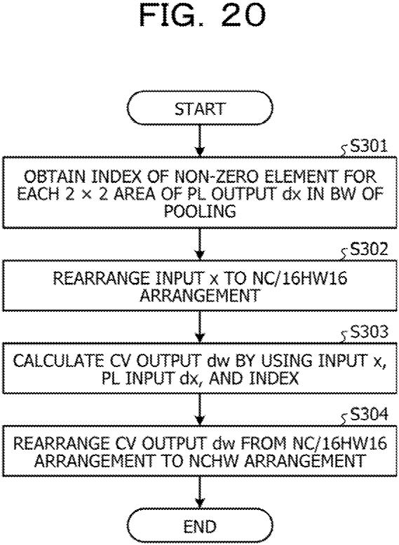

Subsequently, a processing procedure in a case where the present embodiment is applied to a predetermined supercomputer will be described. FIG. 20 is a flowchart illustrating another processing procedure (2) of the information processing apparatus according to the present embodiment. In a case where processing in FIG. 20 is performed, it is assumed that all inputs and outputs are in the NCHW arrangement.

The calculation unit 151 of the information processing apparatus 100 obtains an index of a non-zero element for each 2 × 2 area of the PL output dx in backward (BW) of pooling (Step S301). The calculation unit 151 rearranges the input x to the NC/16HW16 arrangement (Step S302).

The calculation unit 151 calculates the CV output dw by using the input x, the PL input dx, and the index (Step S303). The calculation unit 151 rearranges the CV output dw from the NC/16HW16 arrangement to the NCHW arrangement (Step S304).

In the processing procedure described with reference to FIG. 20, the processing in Step S301 and the processing in S302 have no dependency relationship, so the processing in Step S301 and the processing in Step S302 may be performed in parallel.

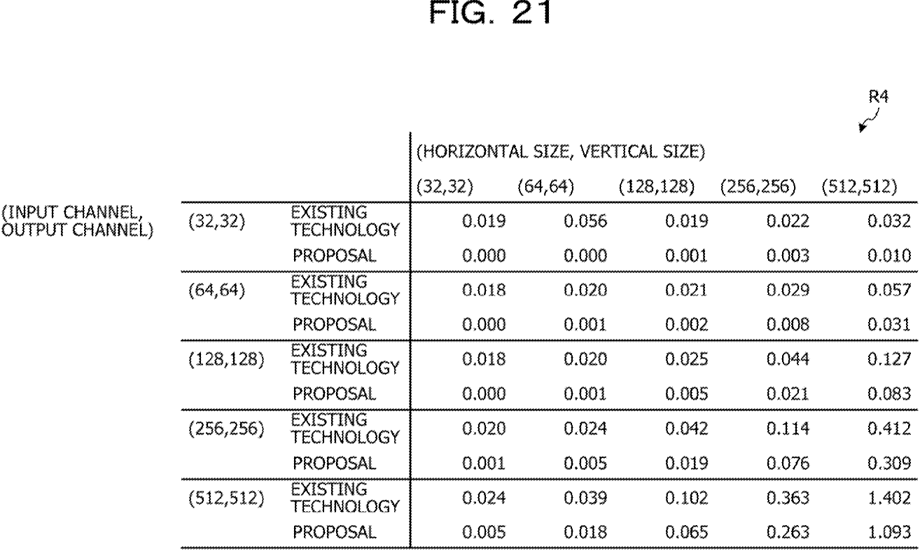

FIG. 21 is a diagram (2) illustrating the result of comparing the execution time of the existing technology and the proposed embodiment. It is assumed that the execution time indicated in FIG. 21 is the total execution time of the processing in Step S301 and the processing in S303. This is because only Steps S301 and S303 among the processing in Steps S301 to S304 are different processing between the naive implementation (existing technology) and the implementation of the proposal.

An execution result R4 in FIG. 21 is execution time in a case where the kernel size is 3 × 3. A first line of the execution result R4 indicates execution time for the respective input image vertical/horizontal sizes (32, 32), (64, 64), (128, 128), (256, 256), and (512, 512) in a case where the number of input chs is 32 and the number of output chs is 32. For all the input image vertical/horizontal sizes, the execution time of the proposal is shorter than the execution time of the existing technology, and speedup is promoted. Although description of other rows of the execution result R4 is omitted, the execution time of the proposal is shorter than the execution time of the existing technology, and speedup is promoted.

Subsequently, among Steps S301 to S304 described with reference to FIG. 20, Steps S301 and S303 will be described for each step.

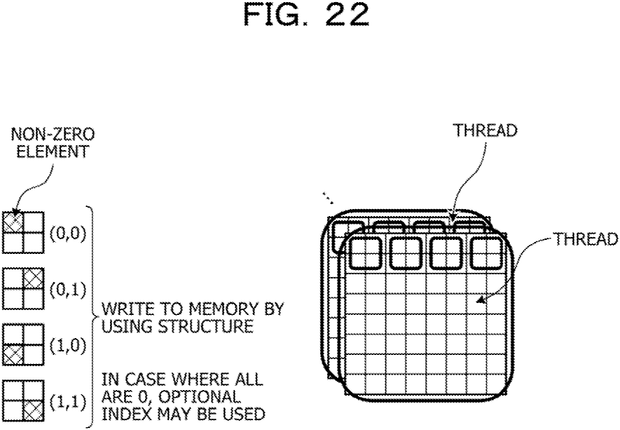

The processing in Step S301 in FIG. 20 will be described. FIG. 22 is a diagram for supplementarily describing the processing in Step S301. In the processing in S301 executed by the calculation unit 151, a thread obtains a non-zero index of 2 × 2 elements of a channel image in charge. It is assumed that an input 1 is “CV output x”, an input 2 is “PL output x”, and an output is “non-zero index”. The calculation unit 151 performs writing to the memory by using a structure of the non-zero index. At this time, the calculation unit 151 writes in the NCHW arrangement. Here, the PL output dx does not need to be written to the memory in order to calculate the CV output dw. In a case where the PL output dx is needed for some other reason, it is sufficient that the PL output dx is written in the processing in Step S301.

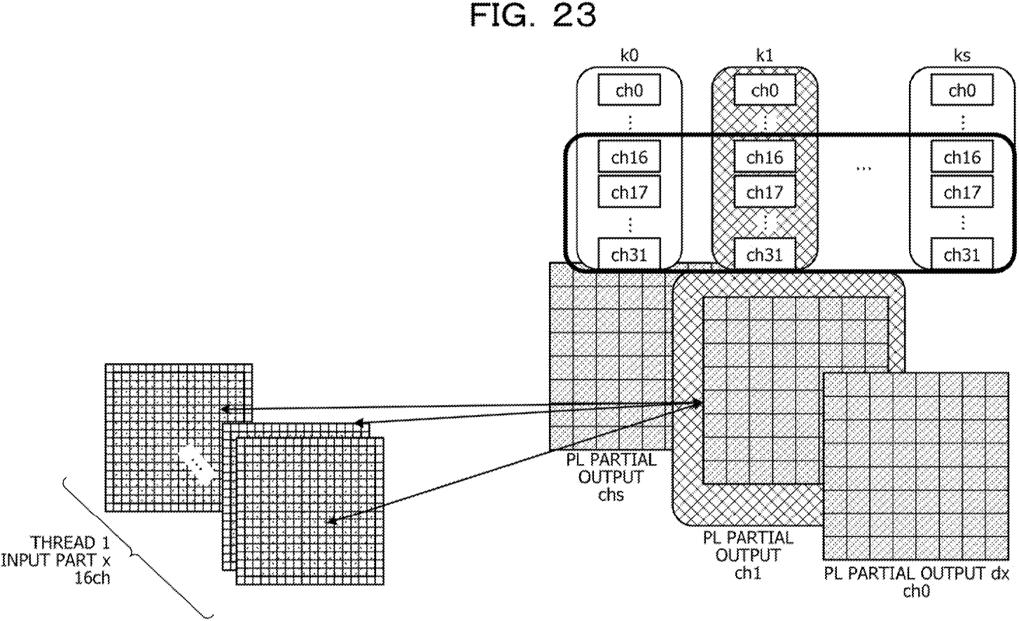

The processing in Step S303 in FIG. 20 will be described. FIG. 23 is a diagram for supplementarily describing the processing in Step S303. A thread is in charge of 16 chs × the input x (images of 0 to 15 chs), and a thread i performs calculations of 0 to 15 chs of a kernel set i. At this time, in a case where the input x is greater than 16 chs, the calculations are repeatedly performed. For example, in a first loop, calculations of 0 to 15 chs are performed. In a second loop, calculations of 16 to 32 chs are performed. The same applies to below.

When the CV output dw is calculated by using the input x and the PL output x, there is no need to divide the input x or the PL output x. Elements needed for the calculation are accessed in raster scan order, starting with an upper left element of the input x. Furthermore, the threads access the same input x. Additionally, in a predetermined compiler, a prefetch is automatically inserted, and it is possible to perform memory access efficiently. Furthermore, each core memory group (CMG) of a64fx has an 8 MB L2 cache. At this time, it is possible to efficiently perform the calculation when a partial area of the cache input x has horizontal elements × 3 elements × 16 chs. Here, the number of bytes needed to be stored in the cache is 4 [bytes] × 512 × 3 × 16 = 98 KB in a case where an image size is 512 × 512. This is well stored in the L2 cache, and when an automatic prefetch by the predetermined compiler is also stored, the entire image may be processed at high speed.

Among Steps S301 to S305 described with reference to FIG. 20, Steps S301 and S303 have been described above.

Note that the present disclosure is not limited to this embodiment, and it is naturally possible to apply the concept of the fusion calculation for the difference output (dx) of pooling (PL) described here this time to the partial weight (CV) difference output dw.

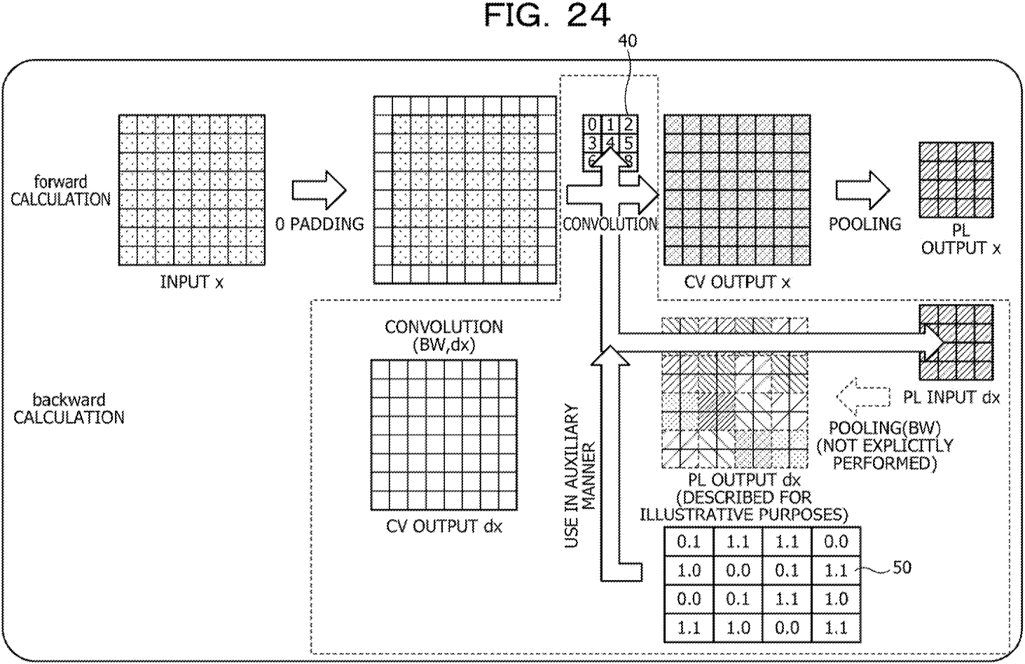

FIG. 24 is a diagram for describing the application to the partial weight (CV) difference output dw. In the example indicated in FIG. 24, in a case where convolution of each element of a kernel 40 and the PL input dx is performed, the calculation unit 151 performs an operation of only a non-zero element based on the index 50.

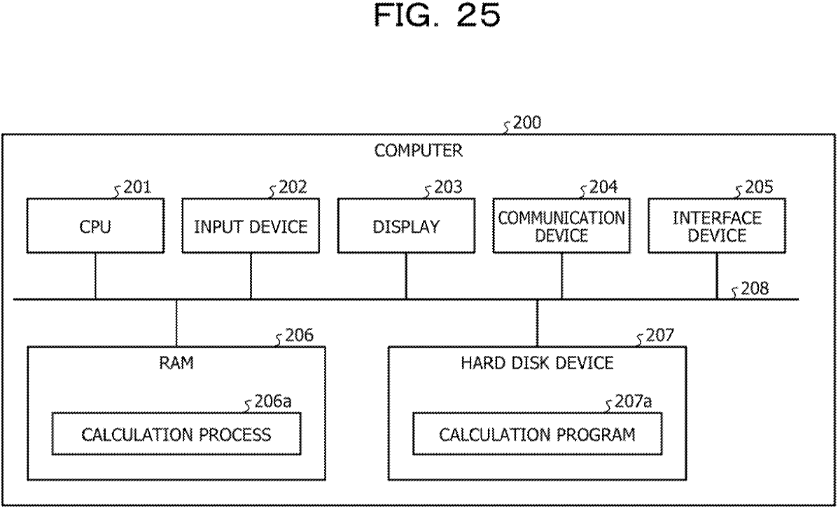

Next, an example of a hardware configuration of a computer that implements functions similar to those of the information processing apparatus 100 indicated in the embodiment described above will be described. FIG. 25 is a diagram illustrating an example of the hardware configuration of the computer that implements the functions similar to those of the information processing apparatus of the embodiment.

As illustrated in FIG. 25, a computer 200 includes a CPU 201 that executes various types of operation processing, an input device 202 that accepts a data input from a user, and a display 203. Furthermore, the computer 200 includes a communication device 204 that exchanges data with an external device or the like via a wired or wireless network, and an interface device 205. Furthermore, the computer 200 includes a random access memory (RAM) 206 that temporarily stores various types of information, and a hard disk device 207. Each of the devices 201 to 207 is coupled to a bus 208.

The hard disk device 207 includes a calculation program 207a. Furthermore, the CPU 201 reads the calculation program 207a, and expands the calculation program 207a in the RAM 206. The calculation program 207a functions as a calculation process 206a. Processing of the calculation process 206a corresponds to the processing of the calculation unit 151.

Note that the calculation program 207a does not necessarily have to be stored in the hard disk device 207 beforehand. For example, each of the programs may be stored in a “portable physical medium” to be inserted in the computer 200, such as a flexible disk (FD), a compact disc read only memory (CD-ROM), a digital versatile disc (DVD), a magneto-optical disk, or an integrated circuit (IC) card. Then, the computer 200 may read and execute the calculation program 207a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a training program for causing a computer to execute processing comprising:
causing a convolution layer included in a network to execute a convolution calculation of forward propagation on first input data output from a layer closer to an input side than the convolution layer;
generating, when a pooling layer included in the network is caused to execute a pooling calculation of forward propagation on output data that serves as an execution result of the convolution calculation, an index in which a position of a non-zero element is set for each predetermined element of the output data; and
causing, when the convolution layer is caused to execute a convolution calculation of backward propagation of the first input data and second input data that is output from a layer closer to an output side than the pooling layer, the convolution layer to execute a convolution calculation of a non-zero element based on the index, the first input data, and the second input data, and to skip a convolution calculation of a zero element.

2. The non-transitory computer-readable recording medium according to claim 1, wherein the processing of causing the convolution calculation of the non-zero element to be executed and causing the convolution calculation of the zero element to be skipped causes a convolution calculation of an element at a position of each predetermined element of the first input data and an element of the second input data, which correspond to the position of the non-zero element set in the index, to be executed.

3. The non-transitory computer-readable recording medium according to claim 2, for causing the computer to execute the processing further comprising:
causing the convolution layer to execute a convolution calculation of forward propagation of a kernel and the first input data; and
updating the kernel based on an execution result of the convolution calculation of the non-zero element.

4. A training method comprising:
causing a convolution layer included in a network to execute a convolution calculation of forward propagation on first input data output from a layer closer to an input side than the convolution layer;
generating, when a pooling layer included in the network is caused to execute a pooling calculation of forward propagation on output data that serves as an execution result of the convolution calculation, an index in which a position of a non-zero element is set for each predetermined element of the output data; and
causing, when the convolution layer is caused to execute a convolution calculation of backward propagation of the first input data and second input data that is output from a layer closer to an output side than the pooling layer, the convolution layer to execute a convolution calculation of a non-zero element based on the index, the first input data, and the second input data, and to skip a convolution calculation of a zero element.

5. The training method according to claim 4, wherein the processing of causing the convolution calculation of the non-zero element to be executed and causing the convolution calculation of the zero element to be skipped causes a convolution calculation of an element at a position of each predetermined element of the first input data and an element of the second input data, which correspond to the position of the non-zero element set in the index, to be executed.

6. The training method according to claim 5, for causing the computer to execute the processing further comprising:
causing the convolution layer to execute a convolution calculation of forward propagation of a kernel and the first input data; and
updating the kernel based on an execution result of the convolution calculation of the non-zero element.

7. An information processing apparatus comprising:
a memory; and
a processor coupled to the memory and configured to:
cause a convolution layer included in a network to execute a convolution calculation of forward propagation on first input data output from a layer closer to an input side than the convolution layer;
generate, when a pooling layer included in the network is caused to execute a pooling calculation of forward propagation on output data that serves as an execution result of the convolution calculation, an index in which a position of a non-zero element is set for each predetermined element of the output data; and
cause, when the convolution layer is caused to execute a convolution calculation of backward propagation of the first input data and second input data that is output from a layer closer to an output side than the pooling layer, the convolution layer to execute a convolution calculation of a non-zero element based on the index, the first input data, and the second input data, and to skip a convolution calculation of a zero element.

8. The information processing apparatus according to claim 7, wherein the processing to cause the convolution calculation of the non-zero element to be executed and cause the convolution calculation of the zero element to be skipped causes a convolution calculation of an element at a position of each predetermined element of the first input data and an element of the second input data, which correspond to the position of the non-zero element set in the index, to be executed.

9. The information processing apparatus according to claim 8, wherein the processor:
causes the convolution layer to execute a convolution calculation of forward propagation of a kernel and the first input data; and
updates the kernel based on an execution result of the convolution calculation of the non-zero element.
